(19) United States
(12) Patent Application Publication
(10) Pub. No.: US 2006/0187949 A1
(43) Pub. Date: Aug. 24, 2006

(54) Queuing and scheduling architecture for a unified access device supporting wired and wireless clients

(76) Inventors: Ganesh Seshan, San Jose, CA (US); Abhijit K. Choudhury, Cupertino, CA (US); Shekhar Ambe, San Jose, CA (US); Sudhanshu Jain, Fremont, CA (US); Mathew Kayalackakom, Cupertino, CA (US)

Correspondence Address: PILLSBURY WINTHROP SHAW PITTMAN LLP, P.O. BOX 10500, MCLEAN, VA, 22102, US

(21) Appl. No.: 11/351,330

(22) Filed: Feb. 8, 2006

Related U.S. Application Data
(60) Provisional application No. 60/651,588, filed on Feb. 9, 2005.

(51) Int. Cl. H04L 12/26

(52) U.S. Cl. 370/412; 370/229

(57) ABSTRACT

Systems and methods applicable to a unified wired/wireless network device are proposed to address quality of service issues and roaming support for wired and wireless clients in a unified wired/wireless network. The proposed solution can include a hierarchical scheduler and shaper mechanism that is able to flexibly support different quality of service disciplines, i.e., strict-priority, guaranteed bandwidth, deficit-round-robin, etc., to allow different levels of maximum and minimum bandwidth allocation to each user or group of users. The solution can also include a dynamic queue assignment mechanism that allows queues to be moved from one queue-group and/or port to another queue-group and/or port, without losing packets, when a wireless client roams between access points within the unified network.

### CROSS-REFERENCE TO RELATED APPLICATIONS

This application claims the benefit of priority from U.S. Provisional Application Ser. No. 60/651,588, filed Feb. 9, 2005, entitled “Queuing Scheduling Architecture for a Unified Access Device Supporting Wired and Wireless Clients”, and which is fully incorporated herein by reference for all purposes.

### BACKGROUND OF THE INVENTION

1. Field of the Invention

Generally, the present invention relates to network devices. More specifically, the present invention relates to systems and methods for queuing and scheduling architecture for a unified access device that supports wired and wireless clients.

2. Description of the Related Art

The Wireless Local Area Network (WLAN) market has recently experienced rapid growth, primarily driven by consumer demand for home networking. The next phase of the growth will likely come from the commercial segment comprising enterprises, service provider networks in public places (Hotspots), multi-tenant, multi-dwelling units (MxUs) and small office home office (SOHO) networks. The worldwide market for the commercial segment is expected to grow from 5M units in 2001 to over 33M units in 2006. However, this growth can be realized only if the issues of security, service quality and user experience are addressed effectively in newer products.

FIG. 1 illustrates an exemplary wired network topology 100 as is known in the art today. As shown in FIG. 1, network 100 can be connected to the Internet 110 via a virtual private network and/or firewall 120, which can in turn be connected to a backbone router 130. Backbone router can be connected, for example, to other network routers 130, 150, as well as one or more servers 125. Router 130 can be connected to one or more servers 135, such as, for example, an email server, a DHCP server, a RADIUS server, and the like. Further, router 130 can be connected to a level2/level3 (L2/L3) switch 140, which can be connected to various end user, or client, devices 145. Client devices 145 can include, for example, personal computer, printers and workstations. Router 150 can also be connected to one or more L2/L3 switches 155, 160. Switch 160 can then be connected to one or more client devices 165.

FIG. 2 illustrates an exemplary unified wired and wireless network topology as is known in the art today. Much of this network is as discussed above with reference to FIG. 1. However, additional wired and wireless elements have been added. For example, router 155 is connected to end user, or client, devices 258. Additionally, L2/L3 switches 140, 160 are also connected to wireless access point (AP) controllers 285, 270, respectively. Each AP controller 285, 270 can be connected to one or more access points 290, 275, respectively. Additional wireless client devices 295, 280 can be wirelessly coupled to access points 290, 275, respectively. Wireless client devices 295, 280, such as desktop computers, laptop computers, personal digital assistants (PDAs), cellular telephones, etc., can connect via wireless protocols such as 802.11a/b/g. to access points 290, 275. Several or more access points 102 can be further connected to an access point controller 285, 270. Switches 140, 155, 160 can each be connected to multiple access points 290, 295, access point controllers 285, 270, or other wired and/or wireless network elements such as switches, bridges, routers, computers, servers, etc. Many possible alternative topologies are possible, and this Figure (and FIG. 1) is intended to illuminate, rather than limit, the present invention.

Unlike wired networks, as illustrated in FIG. 1, wireless networks poses unique challenges in terms of supporting Quality of Service (QoS) for various applications. In a wired enterprise network, packets are typically queued and scheduled using a simple priority-based queuing structure. This is adequate for most applications in terms of service differentiation. However, in wireless networks, the bandwidth supported to the clients is typically much less than in wired networks. For example, an access point (AP) supports 11 Mbps if it is using the IEEE 802.11b protocol and up to 54 Mbps if it is using 802.11g protocol. The wireless client receives data from the AP using a contention-based protocol, which means they are sharing the available bandwidth. The upstream switch to which the AP is connected is receiving data at 100 Mbps or even 1 Gbps from its upstream connections for these wireless clients.

There is an inherent speed mismatch at the switch, 100 Mbps to 1 Gbps, or more, upstream connection vs. 54 Mbps client-side connection. If data is sent to the AP at the high upstream rates of the switch, the AP will not be able to process these packets fast enough and will end up dropping packets, especially since APs are typically low-cost items with limited memory available for buffering. The speed mismatch is further exacerbated when multiple wireless clients are associated with a single AP, which can decrease the maximum bandwidth each wireless client receives. This implies that some fairly sophisticated queuing and scheduling is needed in the switch to be able to provide service differentiation for various applications that the wireless clients would be running. The need for advanced mechanisms is increased in switches that are targeted to unified networks handling both wired and wireless clients.

The IEEE is currently in the process of standardizing a proposal for QoS support for IEEE 802.11x clients. The proposal calls for multiple levels of priorities specified using the traffic identifier (TID) field. TID fields values 0 through 7 are interpreted as user priorities, similar to the IEEE 802.1D priorities. TID field values 8 through 15 specify TIDs that are also traffic stream identifiers (TSIDs) and select the traffic specification (TSPEC) for the stream. If the upstream switch or appliance to which the IEEE 802.11e compliant AP is attached cannot support the same level or granularity of QoS, then just performing prioritized transmissions at the AP would not help much.

One of the key reasons for deploying wireless networks is to give the users the ability to roam. Clients should be able to associate with an AP and if needed, seamlessly transition to another AP as they move from the coverage area of the first AP to the coverage area of the second AP. For this to work well, the user should not have to re-authenticate with the new AP and also should not lose any data being delivered during his transition.

Current. wired L2/L3 switches typically have a limited number of queues and support strict-priority based scheduling. Each port has up to 8 queues to support the 8 different priority levels. However, this is not sufficient to support fine-grained QoS as needed by the TSPECs supported by IEEE 802.11e. Some switches support rate limiting on the egress and may be able to provide some limited support for restricting the transmission bandwidth to the AP. To provide lossless transition, though, a switch would need to be able to move the buffered packets that are queued for the original AP to the queue corresponding to the new AP. No existing switch today has this ability.

Therefore, what is needed is sophisticated queuing and scheduling architecture in a network appliance, such as a unified wired/wireless network device, that can facilitate, among other things, service differentiation and seamless roaming for the wireless clients on a unified wired and wireless network.

### BRIEF DESCRIPTION OF THE DRAWINGS

Aspects and features of the present invention will become apparent to those ordinarily skilled in the art from the following detailed description of certain embodiments of the invention in conjunction with the accompanying drawings, wherein:

FIG. 1 illustrates an exemplary wired network topology as is known in the art today;

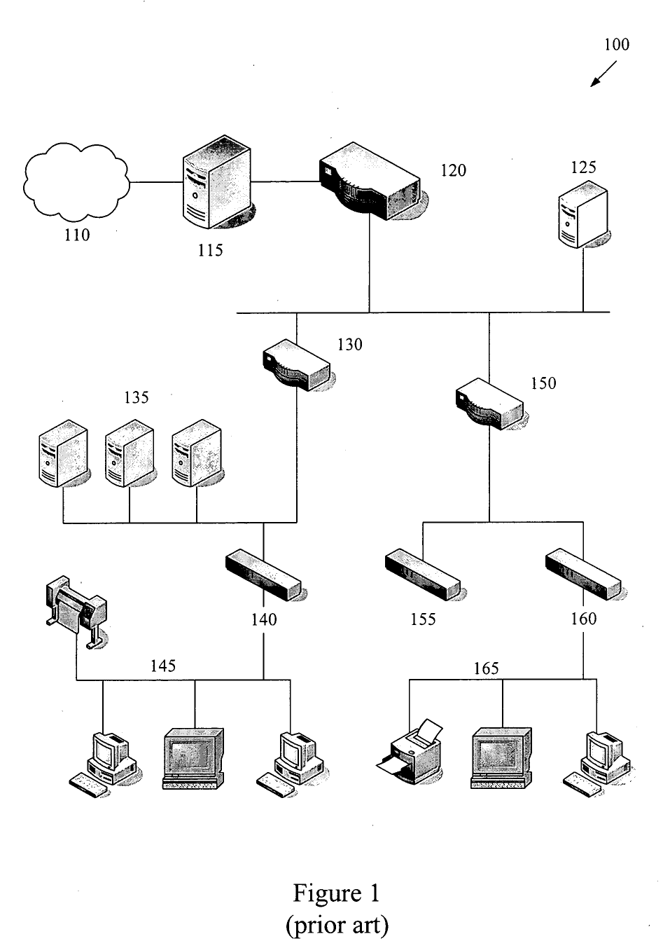

FIG. 2 illustrates an exemplary unified wired and wireless network topology as is known in the art today;

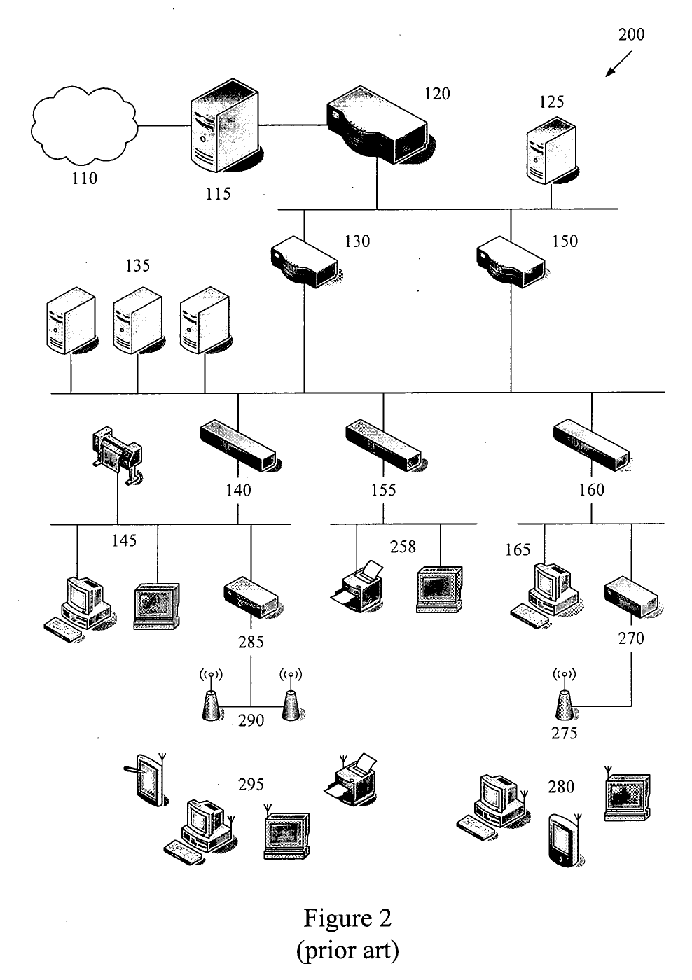

FIG. 3 illustrates exemplary data structures for a queue manager according to certain embodiments of the present invention;

FIG. 4 illustrates an exemplary structure for a queue with unicast and multicast packets according to certain embodiments of the present invention;

FIG. 5 illustrates exemplary data structures for a scheduler according to certain embodiments of the present invention;

FIG. 6 illustrates an exemplary flow for the port selector according to certain embodiments of the present invention;

FIG. 7 illustrates an exemplary flow for the group selection according to certain embodiments of the present invention; and

FIG. 8 illustrates an exemplary flow for the queue selection according to certain embodiments of the present invention.

### DETAILED DESCRIPTION OF THE INVENTION

The present invention will now be described in detail with reference to the drawings, which are provided as illustrative examples of the invention so as to enable those skilled in the art to practice the invention and are not meant to limit the scope of the present invention. Where certain elements of the present invention can be partially or fully implemented using known components or steps, only those portions of such known components or steps that are necessary for an understanding of the present invention will be described, and detailed description of other portions of such known components or steps will be omitted so as not to obscure the invention. Further, the present invention is intended to encompass presently known and future equivalents to the components referred to herein by way of illustration.

Certain embodiments of the present invention utilize a unified architecture where packets are processed by the same device, for example, a unified wired/wireless network device, regardless of whether they have been sourced by wired or wireless clients. The ports in this device are agnostic to the nature of the incoming traffic and are able to accept any packet, clear or encrypted. It should be noted that, while a specific network appliance, like a switch, may be used throughout this disclosure to illustrate aspects and embodiments of the present invention, other network devices or appliances can also be used, and such unified wired/wireless network devices capable of implementing an embodiment of the present invention are intended to be within the scope of the present invention.

Certain embodiments of the present invention include one or more of the following features: large packet buffer, large number of queues, complex scheduling and shaping mechanism, hierarchical queuing and scheduling architecture, and dynamic association of queues to queue-groups and ports. Large packet buffers allow, for example, a large number of packets to be stored in the device instead of at wireless access points (APs) coupled to the device, allowing for shaping and scheduling of traffic to provide fine-grained QoS. A large number of queues, for example, allow queues to be allocated on a per-client basis instead of queuing only aggregated traffic. Assigning per-user/per-flow queues makes it possible to support per-user or per-flow traffic specifications in terms of maximum and committed rates to which a user can subscribe.

Complex and combined scheduling and shaping mechanisms, for example, make it possible to support a wide variety of scheduling algorithms. For example, strict-priority service, guaranteed bandwidth service as well best-effort service with guaranteed minimum bandwidth are all supported by certain embodiments. Each queue can be assigned a maximum rate and a minimum rate which can be enforced by a combined shaping and scheduling mechanism.

With hierarchical queuing and scheduling architecture, for example, each queue can be assigned to a queue group, which is an aggregation of queues, and each queue group can be assigned to a port. Each port can have from one to some upper number of queue-groups, for example 96 queue-groups. This hierarchical mechanism makes it possible to assign maximum and minimum rates to each queue (and hence each client), as well as to each queue-group (and hence each AP).

For the dynamic association of queues to queue-groups and ports, for example, the association between a specific queue to a queue-group and to a port is not fixed, and can be changed dynamically. This makes it possible to assign a queue to a wireless client, and when the wireless client roams from one AP to another AP, and possibly another port, the queue can be moved to associate with the new queue-group and new port. This makes it possible to support lossless transition during a roaming event, since all of the packets already queued up in that particular queue can be moved to the new port.

Certain embodiments of the present invention can include a queue manager (QM). The QM manages the active and free list queues in the device. For example, assume there are 32K packet buffers of 4 KByte each in the packet memory. The pointers to each of these buffers can be maintained in the queue memory. Each queue can be a linked list of these pointers. The device can have, for example, up to 2K active queues; there can also be a queue of free (e.g., unused) buffers. There can be a head and tail pointer for each of the active queues that are maintained in the queue head and the queue tail pointer memories. The free buffer head and tail pointers can be maintained in separate registers. The QM can also support up to 12K multicast packets. The pointers to the multicast packets are maintained in a separate multicast pointer memory.

As used herein, the word “multicast” is used to specify a data buffer of the device being read out multiple times from the packet memory. Multicast could mean broadcast, port mirroring or simply traffic to multiple ports, including the host processor of the device.

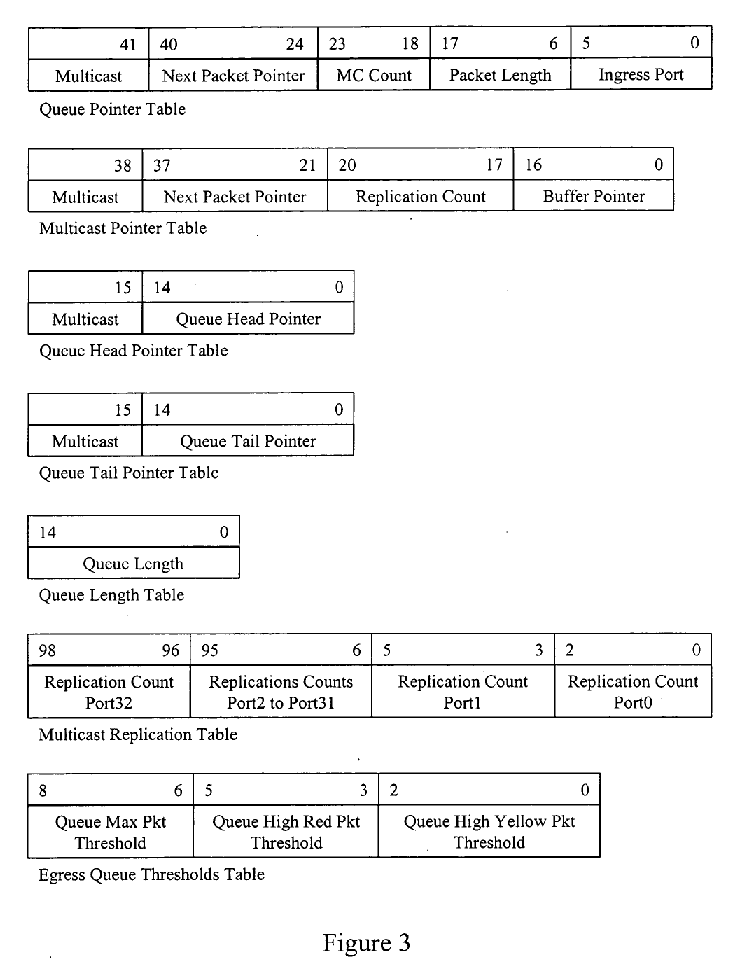

In certain embodiments, the QM can include one or more data structures, such as, for example: a queue pointer table, a multicast pointer table, a queue head pointer table, a queue tail pointer table, a queue length table, a multicast replication table, an egress port threshold and count table and egress queue thresholds. FIG. 3 illustrates exemplary data structures for a queue manager according to certain embodiments of the present invention. Each of these exemplary data structures associated with the queue manager will now be discussed further.

As previously mentioned, the QM can manage the active and free list of queues in the device. In certain embodiments, there are 32K packet buffers and they are referenced via a free buffer pointer maintained in the QM. A queue is a linked list of such buffers and the device can support some number of queues, for example, up to 4K queues. An exemplary structure of a unicast, or regular, buffer pointer is provided in FIG. 3. In this example, the multicast bit identifies that the next packet in the queue is multicast and the pointer to this resides in the multicast pointer memory. The next packet pointer field is the pointer to the next packet in the queue (multicast pointer in the case of the next packet being multicast). The multicast count field reflects the number of ports the multicast packet goes out on. The packet length field is the length of the packet in bytes. The ingress port field provides the ingress port through which the packet arrived in the device.

In the case of multicast, certain embodiments of the invention can support up to 12K multicast packets. Pointers to multicast buffers can be maintained separately in the multicast pointer memory. The structure of this exemplary multicast pointer is shown in FIG. 3. In this example, the multicast bit identifies that the next packet in the queue is multicast and the pointer to this resides in the multicast pointer memory. The next packet pointer field is the pointer to the next packet in the queue (multicast pointer in the case of the next packet being multicast). The replication count field provides the number of replications per port, or the number of time the packet should be read out, for the multicast transmission. The buffer pointer field can be used to point to the next packet in the queue (multicast pointer in the case of the next packet being multicast).

In certain embodiments, the queue head pointer table contains the pointers to the head of each queue. The head pointer words have the pointer to the queue pointer table and a multicast indicator. This table, for example, can be 2K deep and 16 bits wide. Likewise, the queue tail pointer table contains the pointers to the tail of each queue. The tail pointer words have the pointer to the queue pointer table and a multicast indicator. This table, for example, can also be 2K deep and 16 bits wide. Further, the queue length table contains the number of packets in each queue, which can be, for example, 2K deep and 15 bits wide. FIG. 3 provides examples of each of these tables.

In certain embodiments, the multicast replication table can store the per port replication count for each of the multicast groups, for example, 256 multicast groups. Assuming that there are 33 ports, each with a 3 bit replication count, this table can be 256 deep with 99 bit wide words. This table can be accessed using the IP multicast index. An example of this table is illustrated in FIG. 3.

The egress port threshold and count table can store the per egress port occupancy of the packet memory and the maximum threshold on this occupancy, per certain embodiments of the invention. FIG. 3 illustrates an example of this table. When the egress port occupancy exceeds this threshold, the arriving packets can be dropped. This table can be, for example, 33 deep and 18 bits wide.

According to certain embodiments, the egress queue thresholds table can store, for example, three egress queue thresholds that are used to decide whether to admit an incoming packet. FIG. 3 provides an example of this table. The red and yellow thresholds can be used for dropping out-of-profile packets. For example, when the egress queue occupancy exceeds the red packet threshold, only yellow and green packets are admitted; when the yellow packet threshold is exceeded, only green packets are admitted; and when the queue max packet threshold is exceeded, all packets are dropped. The egress queue thresholds table, for example, can be 2K deep and 9 bits wide. Also, the queue thresholds need to be initialized with the respective values.

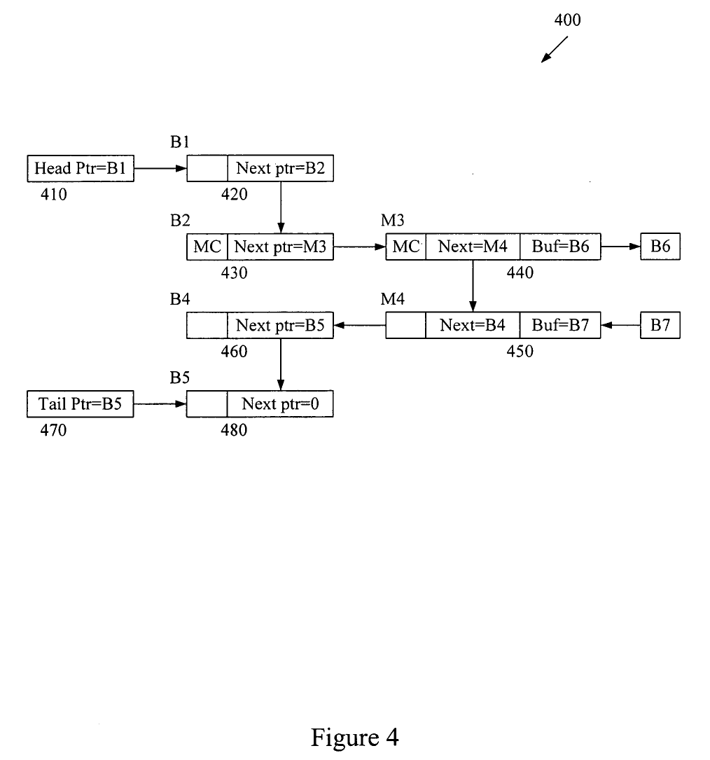

FIG. 4 illustrates an exemplary structure for a queue 400 with unicast and multicast packets according to certain embodiments of the present invention. As shown in FIG. 4, the pointers in the unicast queue pointer memory are indicated by Bx, while the pointers in the multicast pointer memory are indicated by Mz. In this example, a head pointer 410 points to the first packet 420 (unicast) in the queue 420 at location B1. The pointer residing at address B2 has the next packet pointer 430 pointing to a multicast packet MC. Since the next packet in the queue is a multicast packet, the “multicast” bit in the pointer is set, indicating that the next pointer resides in the multicast pointer memory. The multicast (e.g., payload and next element) pointer is in the multicast pointer memory. Note the next packet pointer at B2 points to a location M3 in the multicast pointer memory 440, and does not represent a location in the packet buffer. The multicast pointer residing at M3 points to the next element 450 in the queue M4, which happens to be multicast, and also to the multicast buffer at B6. These pointers have the per port replication count as well. The pointer at M4 points to the next packet 460, which is unicast and located at B4; hence, the multicast bit is reset. Finally, the tail pointer 470 points to the last packet 480 (unicast) in the queue at location B5.

According to certain embodiments, the queue manager will determine the queue number before a packet is placed in a queue, i.e., enqueued. For example, if there are a total of 2K queues, then each of the 96 queue_groups can have eight queues assigned to them. However, these queues need not be used unless a particular queue_group is used.

According to certain embodiments, enqueuing can be initiated by the packet memory controller (PMC), by providing a buffer pointer and a receive port to the QM. The enqueue engine can read the queue tail pointer table to determine the queue tail, and also the queue length for the queue. In the case of a unicast enqueue, the entry in the queue pointer table pointed to by the existing tail pointer can be updated with the newly enqueued packet address as the next pointer. The queue tail pointer table is also updated with the newly enqueued packet address. The queue length in the queue length table is updated by incrementing the original packet count. If the multicast bit in the tail pointer is set, indicating that the queue tail is multicast, then the location pointed to by the queue tail is read from the multicast pointer table. The next pointer field alone in the multicast pointer is updated and written back. The buffer pointer and the replication count are maintained as they are.

In certain embodiments, the scheduler initiates the dequeue process by providing the queue_id and dequeue request to the QM. The dequeue engine reads the queue head pointer table to determine the queue head, and also reads the queue length for the queue from the queue length table. In the case of a unicast dequeue, the location pointed to by the head pointer is read from the queue pointer table. The next pointer value obtained is used to update the queue head pointer table. The original queue head pointer is sent to the packet memory controller for a memory read. The queue length in the queue length table is read, reduced by one and written back. If the multicast bit in the head pointer is set, indicating that the queue head is multicast, then the location pointed to by the head pointer is read from the multicast pointer table. This gives the replication count, the pointer to the next element in the queue and also the pointer to the payload buffer. The buffer pointer is sent to the PMC for the packet memory reads. The replication count is decremented by one. If the new replication count is a non zero value, it is written back to the multicast pointer table. The next pointer value obtained is used to update the queue head pointer table. For a given queue, the packet is read out as many times as required by the replication count. The queue progresses to the next packet, when the replication count of the multicast packet being dequeued, reaches zero, and the multicast pointer is freed up by sending to the multicast free list. The queue length in the queue length table is read, reduced by one and written back.

In certain embodiments, the network device implementing the present invention can have a scheduler that is hierarchical and schedules traffic at three levels: port, queue group and queue. For example, traffic destined for each egress port of a switch is served from the queue based quality of service parameters for each queue. At least some of the main functions of the scheduler can be summarized as: port selection based on the port bandwidth, queue group scheduling based on group shaping requirements and intra group bandwidth distribution, and queue scheduling based on quality of service, shaping and intra queue bandwidth distribution.

According to certain embodiments of the present invention, a scheduler can be included into the incorporating network device. The scheduler can be designed in a unified wired/wireless network device, for example a switch, to handle a total of 96 groups and 33 ports. The host and Ethernet port extension (EPE) ports can have only one group. Further, for example, each queue group can have a maximum of 64 queues. Within each group, there can be three priorities of queues: high priority queues, which are serviced with strict priority, medium priority queues, which are serviced with guaranteed bandwidth, and low priority queues, which are serviced with deficit round robin (DRR). Of the 64 queues per group, up to 4 queues can be high priority, up to 12 queues can be medium priority and up to 48 queues can be low priority. However, those skilled in the art will now realize that other combinations are possible.

In certain embodiments, the scheduler can first select the ports based on the bandwidth of the ports. Within the port, a queue group can be selected from the eligible groups based on the bandwidth requirements; eligibility here is determined by the maximum rate at which the queue group is allowed to transmit. Within the selected group, a queue is selected among from the high, medium and low priority queues.

Scheduler/Shaper Data Structures

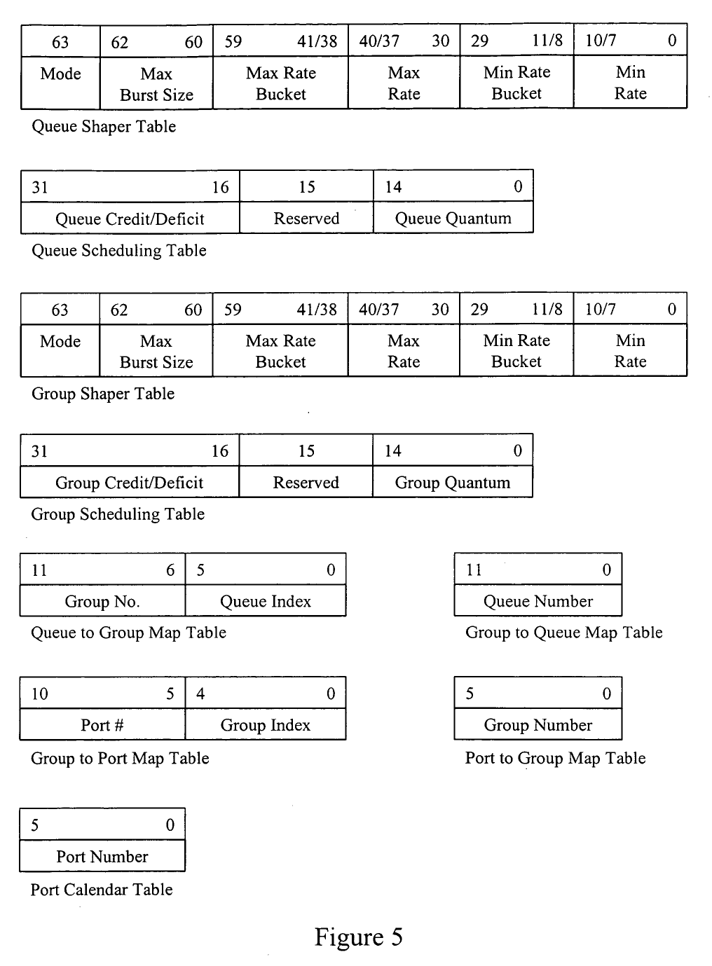

In certain embodiments, the scheduler can include one or more data structures, such as, for example: port enable register, queue shaper token update interval register, group shaper token update interval register, queue shaper table, queue scheduling table, queue empty flags table, queue out of scheduling round flags table, queue enable table, group enable table, group shaper table, group scheduling table, queue to group map table, group to queue map table, group to port map and port calendar table. FIG. 5 illustrates exemplary data structures for a scheduler according to certain embodiments of the present invention. Each of these exemplary data structures associated with the scheduler will now be discussed further.

The scheduler can include, for example, a port enable register, which includes a port enable field. In the port enable field, each bit can be used to enable or disable the corresponding egress port of the network device (e.g., switch). However, the host port (e.g., port 32) should not be disabled. The bits in this register can be changed at any time.

The scheduler can include, for example, a queue shaper token update interval register, which can include an interval field. In the interval field, the queue shaper token update interval can be set. The update interval should be specified as a number of clock cycles. It is desirable, but not required, that this register be written into only during initialization because updates during normal operation could possibly result in wrong updates for one update clock cycle.

The scheduler can include, for example, a group shaper token update interval register, which can include an interval field. In the interval field, the group shaper token update interval can be set. The update interval should be specified as a number of clock cycles. It is desirable, but not required, that this register be written into only during initialization because updates during normal operation could possibly result in wrong updates for one update clock cycle.

The scheduler can include, for example, a queue shaper table, as illustrated in FIG. 5. The queue shaper parameters are stored in this table, on a per queue basis. For example, there can be 2K entries and the entries can be addressed by physical queue number. In this case, each entry can be 64 bits wide. The shaper parameters in the queue shaper table can operate in one of two modes defined by granularity of bandwidth allocation: 1 Mbps or 8 Kbps. The mode bit can indicate I which mode to operate; mode equal to zero implies 8 Kbps and mode equal to one implies 1 Mbps. The max rate and max rate bucket together occupy 30 bits in total, but each field has a different width depending on the mode selected. The same applies for the min rate and min rate bucket fields. For 1 Mbps mode, which applies to flows from 1 Mbps to 1 Gbps, the bucket fields are 19 bits while the rate fields use 11 bits. For 8 kbps mode, which applies to flows from 8 kbps to 1 Mbps, the bucket fields are 22 bits while the rate fields use 8 bits. The max burst size field can indicate burst sized from 256 Kbytes for 'b111 down to 2 Kbytes for ′b000. The default values for the shaper parameter table entries are indeterminate, which indicates that this table should be initialized.

The scheduler can include, for example, a queue scheduling table, as illustrated in FIG. 5. The queue scheduling parameters are stored in this table. The queue quantum field and the credit/deficit field values are in bytes. Bit [31] can be the sign bit for the credit/deficit value. Bit [15] is reserved. The initial values should be the same for the quantum and the credit/deficit fields. The initial sign bit for the credit/deficit fields (bit [31]) should be set to zero. The default values of the scheduling parameter table entries are indeterminate, which indicates that this table should be initiated.

The scheduler can include, for example, a queue empty flags table, which has one field, the queue empty field. The queue empty flags are stored in this table, which can be indexed by the queue group number. This table can be, for example, 96 deep and each entry can be 64 bits wide. In the queue empty field, each bit has the empty condition for the queue addressed by the queue index within the given group. The queue number can be the position or index of the queue within the group. Since all queues are initially empty, this table can be initially set to: OxFFFF_FFFF_FFFF_FFFF.

The scheduler can include, for example, a queue out of scheduling round flags table, which has one field, the out of round field. The queue out of scheduling round flags are stored in this table, which can be indexed by the queue group number. This table can be, for example, 96 deep and each entry can be 64 bits wide. In the out of round field, each bit has the out of round condition for the queue addressed by the queue index within the given group. The queue number can be the position or index of the queue within the group. Since all queues are initially in the round, this table can be initially set to: Ox00000000_{—}0_{—}000_{—}0000.

The scheduler can include, for example, a queue enable table, which has one field, the queue enable field. The queue enable bits are stored in this table, which can be indexed by the queue group number. This table can be, for example, 96 deep and each entry can be 64 bits wide. In the queue enable field, each bit has the enable for the queue addressed by the queue index within the given group. The queue number can be the position or index of the queue within the group. Since all queues are initially enabled, this table can be initially set to: OxFFFF_FFFF_FFFF_FFFF.

The scheduler can include, for example, a group enable table, which has one field, the group enable field. The group enable bits are stored in this table, which can be indexed by the port number. This table can be, for example, 33 deep and each entry can be 48 bits wide. In the group enable field, each bit has the enable for the group addressed by the group index within the given port. The group number can be the position or index of the queue group within the port. The initial values for this table can be based on the groups enabled. All 48 bits for each entry are valid for the GE ports (4-7), and bits [15:0] are valid for FE ports (8-31). For the rest of the ports only bit [0] is valid.

The scheduler can include, for example, a group shaper table, as illustrated in FIG. 5. The group shaper parameters are stored in this table, on a per group basis. This table can be, for example, 64 deep and each entry can be 64 bits wide. The shaper parameters in the group shaper table can operate in one of two modes defined by shaping bandwidth granularity: 1 Mbps or 8 Kbps. The mode bit can indicate I which mode to operate; mode equal to zero implies 8 Kbps and mode equal to one implies 1 Mbps. The max rate and max rate bucket together occupy 30 bits in total, but each field has a different width depending on the mode selected. The same applies for the min rate and min rate bucket fields. For 1 Mbps mode, which applies to flows from 1 Mbps to 1 Gbps, or higher, the bucket fields are 19 bits while the rate fields use 11 bits. For 8 kbps mode, which applies to flows from 8 kbps to 1 Mbps, the bucket fields are 22 bits while the rate fields use 8 bits. The max burst size field can indicate burst sized from 256 Kbytes for 'b111 down to 2 Kbytes for 'b000. The default values for the shaper parameter table entries are indeterminate, which indicates that this table should be initialized.

The scheduler can include, for example, a group scheduling table, as illustrated in FIG. 5. The group scheduling parameters are stored in this table. The quantum field and the credit/deficit field values are in bytes. Bit [31] can be the sign bit for the credit/deficit value. Bit [15] is reserved. The initial values should be the same for the quantum and the credit/deficit fields. The initial sign bit for the credit/deficit fields (bit [31]) should be set to zero. The default values of the scheduling parameter table entries are indeterminate, which indicates that this table should be initiated.

The scheduler can include, for example, a queue to group map table, as illustrated in FIG. 5. For a given queue, the group no. and the position of the queue flags within the group can be specified in this table. The group values can be, for example, from 0x0-0x3F, and the queue index values can be, for example, from 0x0-0x3F. The default values of the queue to group map table entries are indeterminate, which indicates that this table should be initiated.

The scheduler can include, for example, a group to queue map table, as illustrated in FIG. 5. For a give group and queue index, the queue number can be obtained from this table. The table can be addressed with the {group number, queue index}. Each group can have, for example, up to 64 queues. Thus, in total there can be up to 4096 possible addresses. Only 2048 of the 4096 values will be valid at any given point of time, since in the present switch example there are only 2048 queues. The queue values can be from 0x0-0x7FF. The default values of the group to queue map table entries are indeterminate, which indicates that this table should be initiated.

The scheduler can include, for example, a group to port map table, as illustrated in FIG. 5. For a give group, the port number and the position of the group flags within the group can be specified in this table. The port values can be, for example, from 0x0-0x21, and the group index values can be, for example, from 0x0-0x1F for GE ports, 0x0-0xF for FE port, and 0x for EPE and host ports. This table is addressed with the group number. The default values of the group to port map table entries are indeterminate, which indicates that this table should be initiated.

The scheduler can include, for example, a port to group map table, as illustrated in FIG. 5. For a given group, the port number and the position of the group flags within the group can be specified in this table. The port values can be, for example, from 0x0-0x21, and the group index values can be, for example, from 0x0-0x1F for GE ports and 0x0-0xF for FE port, and 0x0 for EPE and host ports. This table can be addressed with the {port number, group index}. For FE ports (8-31), addresses 0-15 are for port 8, 16-31 are for port 9, 32-48 are for port 10 and so on until port 31. For GE ports (4-7), addresses 384-415 are for port 4, 416-447 are for port 5 and so on until port 7. For EPE and host ports, address 512-EPE0, 513-EPE1, 514-EPE2, 515-EPE3, and 516-Host. Locations 517-527 can be reserved. The queue values can be, for example, from 0x0-0x7FF. The default values of the port to group map table entries are indeterminate, which indicates that this table should be initiated.

The scheduler can include, for example, a port calendar table, as illustrated in FIG. 5. The port calendar can be stored in this table. The port scheduling sequence should be specified in this table. It should be the same as the PMC port calendar table. Values can be from 0x0-0x20. The default values of the port calendar table entries are indeterminate, which indicates that this table should be initiated.

According to certain embodiments of the invention, traffic shaping allows for control of the traffic that goes out on an interface in order to match its flow to the remote interface to which it is coupled, and to ensure that the traffic confirms to policies contracted to it. The token bucket algorithm can be used for shaping. For example, each token bucket can be programmed with maximum rate, which determines the rate at which the tokens are added to the bucket, and bucket or burst Size, which determines the maximum number of outstanding tokens that can be in the bucket at any time. The minimum granularity supported for the rate is, for example, 8 Kbps for bandwidth starting from 8 Kbps and going to 1 Mbps. Above 1 Mbps the minimum granularity supported is 1 Mbps and can go up to, for example, 1 Gbps, or higher, for the Gigabit interfaces. The Bucket size can take values from, for example, 4 Kbytes to 512 Kbytes.

All the queues are subject to maximum rate shaping. For each queue, tokens are added to the bucket at the configured rate as long as the number of accumulated tokens is less than the configured burst size. The token bucket is decremented by the appropriate amount when a packet is scheduled form the queue. The queue cannot be serviced if there are fewer tokens in the bucket than required by the packet at the head of the queue; such a queue is deemed ineligible for scheduling. Queue groups are also subjected to maximum rate shaping. The operation is exactly like queue shaping, and queue group is ineligible for service if there are insufficient tokens available.

The scheduler according to certain embodiments goes through three phases of selection: port, group and queue. After the queue is selected it is sent to the QM for scheduling. The following sections describe the building blocks and the various phases of selecting the ports, groups and queues according to various aspects of the present invention.

The port selector selects the port from which to dequeue the next packet. In the switch example, the total number of ports is 33, including the CPU and EPE ports. During normal scheduling, each port is selected based on its rate. For a GE port, a minimum size packet of 64 bytes need to be scheduled every 672 ns. For an FE port this is around 6720 ns. For the overall rate of 8.4 G, a packet needs to be scheduled every 80 ns, which is about 16 clocks.

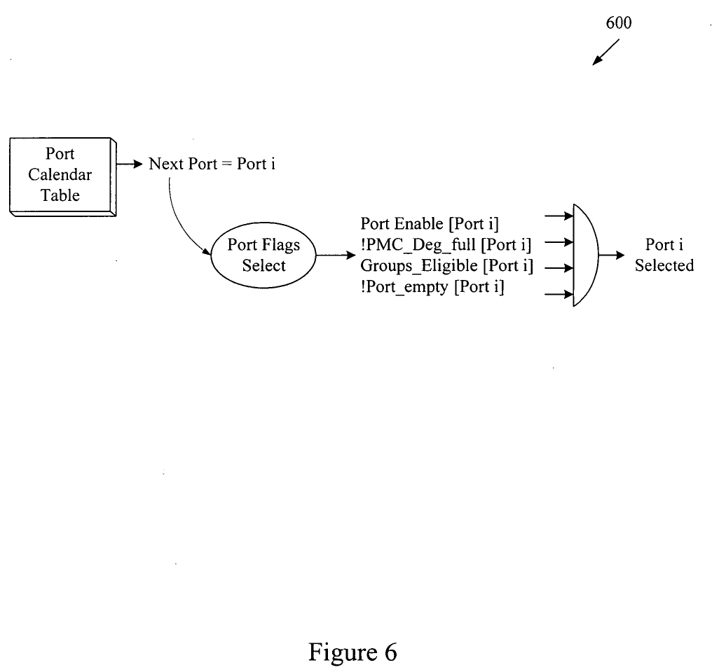

FIG. 6 illustrates an exemplary flow 600 for the port selector according to certain embodiments of the present invention. As shown in FIG. 6, the port selection can be qualified by the port enable, back pressure from the PMC, group eligibility and the port empty flags. The group eligibility for a port means that at least one group in the port has not exceeded the max rate allocated to it. Port empty signifies at least one non empty group within the port. Port selection is also affected by the back pressure from the PMC as a basis for port selection. There will be two threshold signals from the PMC per port: almost full and almost empty. When the dequeue buffer pointer FIFO for a given port in the PMC reaches almost full, implying that the egress port is backing up, the scheduler stops scheduling for that port. When the FIFO level reaches almost empty, that port is given priority for scheduling.

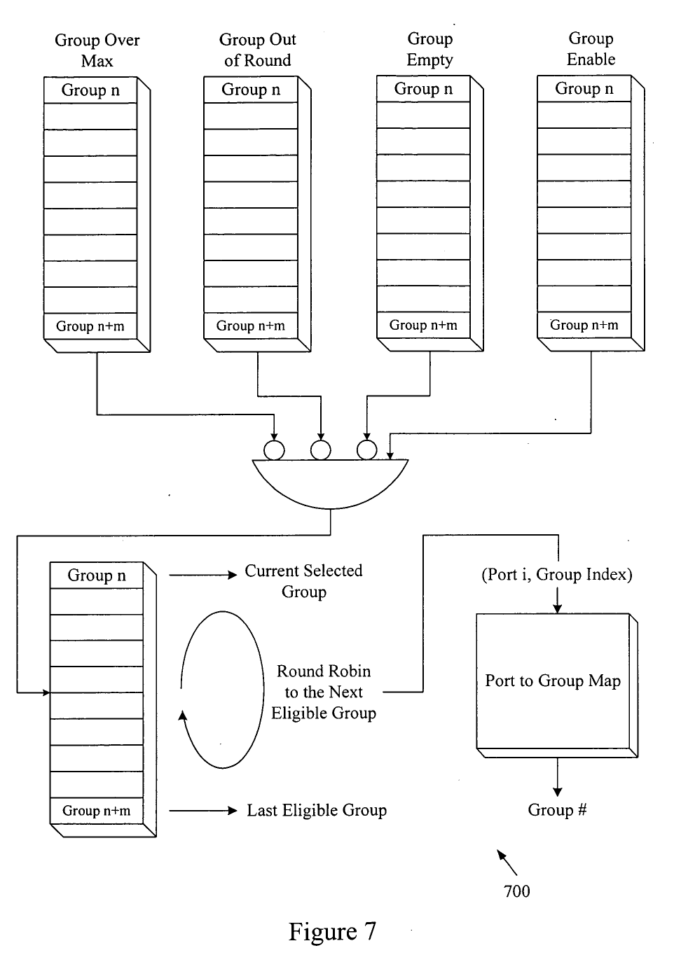

According to certain embodiments of the present invention, each port can have up to 48 queue groups associated with it. Once a port is selected as described above, the next eligible group in the port has to be scheduled. FIG. 7 illustrates an exemplary flow 700 for the group selection according to certain embodiments of the present invention. As shown in FIG. 7, the groups are individually shaped for maximum rate and the bandwidth distribution is performed with the deficit round robin (DRR) algorithm that is explained in further detail below. The DRR algorithm allows the bandwidth to be distributed proportionally between the queue groups based on configured parameters.

The groups can also be individually enabled. The empty, over max and out of round are maintained per group. The empty flags are updated on an update from the queue manager, after an enqueue or dequeue. The empty flag for a group is set to 1 when all the queues in the group are empty and is set to 0 when the group has at least one non empty queue. Once the next eligible group in the port is determined, the group number should be determined. This can be accomplished by referring to the port to group map table, with the {port#, group index} as the address. A list of eligible queue groups is maintained based on which groups have not yet exceeded their maximum transmit rate constraint. The selection of the next queue group to be serviced is based on the DRR algorithm, which is explained below.

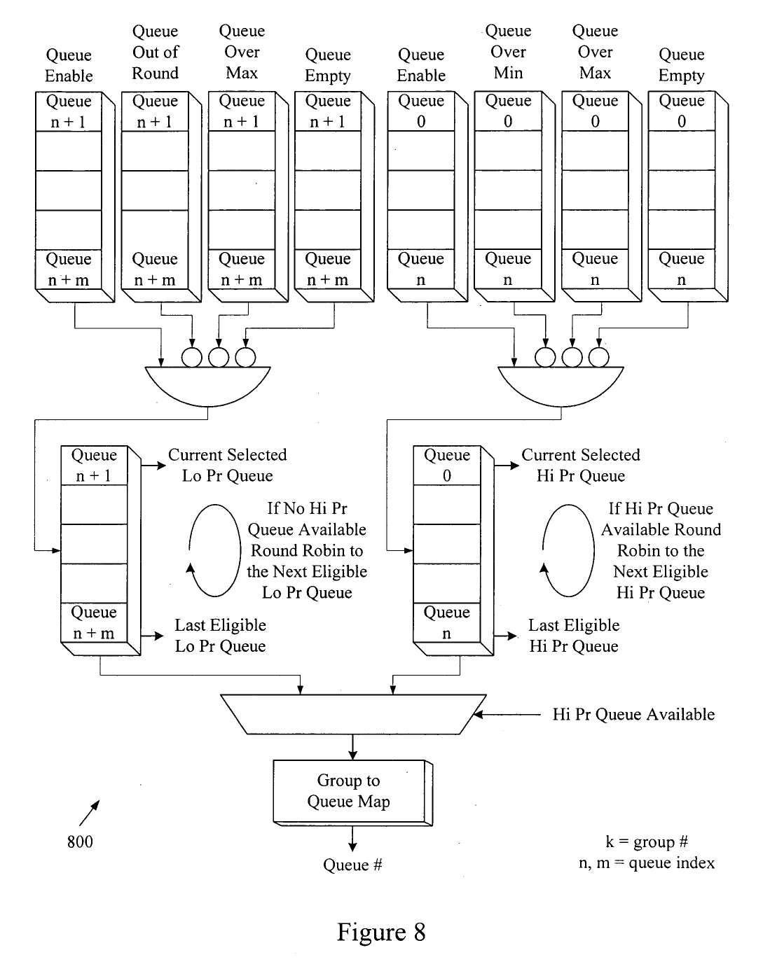

According to certain embodiments, there can be three categories of queues within a queue group: strict priority, guaranteed bandwidth and best effort. FIG. 8 illustrates an exemplary flow 800 for the queue selection according to certain embodiments of the present invention. The packets in the strict priority queues should be processed first. The scheduler goes through each queue starting from highest priority queue. The packets in the highest priority queue are served first. Only when the highest priority queue is empty then the scheduler goes to next queue. If the strict priority queues have no packets or are ineligible because they have exceeded their configured maximum rate, the queues in the guaranteed bandwidth class are serviced next. The guaranteed rate is satisfied using a token bucket algorithm using the guaranteed rate and burst size as parameters. This is similar to shaping on the guaranteed bandwidth for these queues.

If there is any bandwidth left after serving the strict priority and guaranteed bandwidth classes, the queues in the best effort class are served using the deficit round robin (DRR) algorithm. DRR works by associating a time quantum with each queue that is to be serviced. At the start of a scheduling round, a quantum is added to the credit. Backlogged queues are serviced in a round-robin order, and on each round, the amount of data sent from a queue cannot exceed the credit for that queue. If a packet cannot be completely serviced on a round without violating the credit requirement, its transmission is deferred to the next round, but the credit for the queue that was unused in the current round is saved, and can be added to and reused with the quantum for the next round (hence the term “deficit” round-robin). If a queue ever becomes empty, then it cannot carry over any deficit, thereby ensuring that the accumulated deficit can never exceed the length of a maximum sized packet. Also, is the credit drops to a negative value (deficit), the queue is dropped from the scheduling round. This continues until the entire queues drop out of the scheduling round. Then a new round starts, and the quantum is added to the credit to make them positive. Note that although DRR is fair in terms of throughput, it lacks any reasonable delay bound.

All the queues are shaped to a maximum rate implemented with a token bucket. At any point in time, if there is a packet in a queue belonging to the strict priority class, that packet is served as long as the maximum rate for that queue is not violated. Then the guaranteed rates of the guaranteed rate class are satisfied. After that, the remaining bandwidth is divided up between the queues in the best effort class using DRR. If none of the best effort queues can be serviced because of the queues exceeding the maximum rate, the excess bandwidth is allocated to the guaranteed rate queues, which have not exceeded their maximum rate.

According to certain embodiments of the present invention, the scheduler and shaper parameters associated with the queue/group shaper/scheduling tables of FIG. 5 include: maximum transmit rate shaping, minimum transmit rate shaping, DRR credit/debit weight, scheduling flags, port-group-queue maps, and parameter-flag updates. Each of these exemplary parameters will now be discussed in further detail with respect to the switch example.

The maximum transmit rate is limited with a token bucket. There is one token bucket per queue. The parameters required for token bucket shaping are bucket, maximum rate and the maximum burst threshold. The shaper supports a granularity of 8 kbps for bandwidths from 8 kbps to 1 Mbps, and a granularity of 1 Mbps for bandwidths from 1 Mbps to 1 Gbps, or higher. Since the scheduler supports 2K queues, there are 2K token buckets for max rate shaping. Since all are buckets updated sequentially, the update interval can be fixed at about 16000 ns. For a bandwidth of 1 Gbps, one bit needs to be added to the token bucket every 1 ns. The max bucket is the max burst supported for the flow.

For an 8 kbps up to 1 Mbps flows, one bit needs to be added every 125000 ns. Thus, 0.128 bits need to be added every 16000 ns. This translates to one bit every 7.8 update cycles. For a 1 Mbps flow this is 125 bits every 7.8 update cycles, or 16 bits every update cycle. For an 8 kbps granularity, if one bit is one token, a 20 bit wide space would give 512 kbits, which is 64 Kbytes. Since the max burst size which needs to be supported is 256 Kbytes, the bucket size should be 21 bits for the bye count. Since bit is required as a sign bit, the bucket field is 22 bits wide. Since the maximum tokens per update cycle for a 1 Mbps flow is only 16 bits, the rate field width is chosen as 8 bits.

For 1 Mbps up to 1 Gbps flows, the granularity is 1 Mbps. This is 16 bits every update cycle. So, if we have a byte wise granularity, the bucket size with the sign bit needs to be 19 bits wide, to support a max burst size of 256 Kbytes. Since 2 kbytes need to be added every update cycle for a 1 GBps flow, the rate field is 11 bits.

The minimum transmit rate shaping provides guaranteed bandwidth to the queues in the Guaranteed Rate class. This is done with a token bucket, and the field widths are similar to those for the maximum rate shaping. Note that the min rate token bucket applies only to high priority queues. For best effort queues we do not guarantee bandwidth. However, this field is there for all the queues which give the flexibility to guarantee bandwidth to any of the 2k queues.

As previously noted, the low priority queues are serviced with the deficit round robin (DRR) algorithm. Each of the low priority COS queues has a credit/deficit bucket. In the beginning of a DRR round, the bucket is positive. As each packet is scheduled for the queue, the packet length is subtracted from the bucket, until the bucket goes negative (deficit). Then this queue drops out of the round. When all the eligible queues of a DRR group drop out of the round, a new round starts, with every queue having a credit. The COS queues for a given group form a DRR group. So we have a DRR queue group and a high priority queue group corresponding to each of the 96 port groups supported.

The DRR previously described proposes to dequeue a flow, until either the quantum is finished for the queue or the queue goes empty. One approach that can be used is to round robin between the flows on packet boundaries, and subtract the packet length at each instance and calculate the new credit for the flow. As the credit goes negative (deficit), drop the flow from the current round. This is the approach we adopt. The max latency from a queue will be 2.5 Kbytes since that is the max packet length being supported.

The port, group and queue selections are based on the various shaping and scheduling conditions being satisfied. The scheduler keeps track of the following flags to schedule a port, group or queue, and can include: empty, out of round, over min and over max. The queue flag can apply to an empty queue, all queues in a group or all groups in a port. The empty condition can be propagated from the queue all the way up to the port. A queue is excluded from consideration if it is empty, as is a group or a port. The out of round flag can apply to a queue or a group that is out of a particular scheduling round. This flag is maintained for all the groups and low priority queues. The over min flag is maintained for all high priority queues and denotes when a high priority queue has exceeded a minimum guaranteed bandwidth. The over max flag is maintained for all queues and groups and indicates when a group or queue has exceeded the maximum bandwidth.

The port, group and queue map tables specify the mapping between ports and groups, and groups and queues. There are a total of four map tables in the scheduler. They are the illustrated in FIG. 5. In the following cases when “index” is mentioned, it refers to the index of a group or a queue within a specified selection. Since the groups and queues are selected by examining the respective flags for that group and port, the index acts as a second level of reference for a given group or queue.

Consider the following example. Port 0 has groups 2, 5 and 9 associated with it. Group 2 has queues 7, 67, 96 and 45, Group 5 has queues 100,112,100, 1500 and Group 9 has queues 121, 275 and 1750 associated with it. Assume Group 9 is currently scheduled, and group 5 is next in line to be scheduled. Once port 0 is selected for scheduling, the physical group number is not available along with the scheduling flags. The flags are referred to as port[i].group[n], where i refers to the physical port, but i refers to the position of a flag within the set of group flags associated with port i. In the given example, group 5 is ideally indexed as port[0].group[1]. This mapping is stored elsewhere as described below. Similarly for the queues, a queue within a port is referred to as group[n].queue[m], where n is in fact the physical group, but “m” is the position or “index” of the queue flags within the group. In the example above group[5].queue[2] is 100. The groups to queue mappings are stored in tables described below. The indexing is done for the convenience of the hardware, in group and queue selection.

The queue manager updates the scheduler on enqueues and dequeues. The scheduler needs to keep track of the empty condition of queues to avoid scheduling an empty queue for dequeue. The DRR credit and the token buckets need to get updated as well. So, the queue manager passes the packet length of the dequeued packet. The length of the dequeued packet is subtracted from the DRR credits, the max rate and min rate token buckets. The DRR credits are irrelevant for guaranteed bandwidth flows, and min rate is irrelevant for best effort queues.

Once a packet is dequeued to the PMC, the queue manager gives the packet length, empty flag and the queue number to the scheduler. Also when a packet is enqueued to an empty queue, the queue manager provides the queue number to the scheduler. The DRR and the shaping memories are updated with the queue number as the address. The following illustrates the parameter calculations and updates:
New DRR Credit=DRR Credit-Packet Length,
New Max Rate Bucket=Max Rate Bucket-Packet Length, and
New Min Rate Bucket=Min Rate Bucket-Packet Length.

The group number and the index of the queue within the group are obtained from the queue to group map table. The port number and the index of the group within the port are obtained from the group to port map table. The group DRR credits and max rate bucket parameters are updated as well, as mentioned above. Once the parameters are calculated for the groups and queues, the queue and group flags values are updated with the new values as follows.
Queue Empty=Empty Flag on Dequeue from Queue Manager,
Queue Not Empty=Not Empty Flag on Enqueue from Queue Manager,
Queue Out of Round=New Queue DRR Credit negative or zero,
Queue Over Max Rate=New Queue Max Rate Bucket negative or zero,
Queue Over Min Rate=New Queue Min Rate Bucket negative or zero,
Group Empty=All queues in the group are empty,
Group not Empty=One queue in an empty group going non empty,
Group Out of Round=New Group DRR Credit negative or zero, and
Group Over Max Rate=New Group Max Rate Bucket negative or zero.

Note that the Groups do not have a “over min rate” flag since DRR is run on all of the groups without priority/guaranteed bandwidth. A new DRR round is started once all the groups or queues are out of the round. At this point all the flags are reset and a new round is started for that group or port.

The queue and group rate shaping token buckets are updated regularly. The update interval can be programmed. During a token update the rate token is added to the bucket as shown below.
New Max Rate bucket=Current Max rate bucket+Max rate
New Min Rate bucket=Current Min Rate bucket+Min rate

During a token update, if the max or min rate buckets go positive the max rate and min rate flags are reset, since the given groups or queues are no longer over the max or min.

Certain embodiments of the present invention allow for the ability of a wireless client to roam between and among various access points with having to re-establish with the new AP and without loosing data in the process. The scheduler, as described above, allows any queue to be attached to any group and hence any port. For a queue to roam to a different group/port, for example, the following sequence of events takes place.

The queue that has to migrate because of a roaming client should be disabled through the queue enable table in the scheduler. The table is accessed with the group number. The queue index indicates the bit position within the 64 bit enable word for a given word. A port number field of the queue enable table is used to indicate the original port from which the roaming began, and the roam operation type field indicates the starting or completion of a roaming operation.

The roam start command can now be issued by providing the queue that has to be moved, the original port to which this queue was attached, and the operation type of START. This command detaches the queue from the original port by subtracting the queue length from the port occupancy. Further enqueues to this queue will only increment the queue length and not any port count.

Then, the roaming queue has to be attached to a new group. The queue to group map table and the group to queue map table are changed to reflect the new queue to group association. The queue to group map is addressed with the queue number. The new group and the index of the queue within the group have to go in here. The index depends on the type of queue, i.e., best effort, guaranteed bandwidth or priority. Once this is done, the group to queue map has to be changed. The group to queue map table has to be addressed with the {new group, new index}.

Other tables will likely need to be updated as well because of the roaming. For example, if the packets going to this queue were being directed from the L2 Table, then the PortNum field in the L2 Table needs to be updated to point to the new port.

Finally, the roam complete command should be issued by writing to the roam command register providing the queue that has to be moved, the new port to which this queue is to be attached, and the operation type of “complete”. This command attaches the queue to the new port by adding the queue length to the port occupancy. Also, status bitmaps, like scheduler empty, over max, etc., are updated in the scheduler to indicate the presence of this queue at the new port. The queue is now re-enabled by writing into the queue enable table.

Although the present invention has been particularly described with reference to embodiments thereof, it should be readily apparent to those of ordinary skill in the art that various changes, modifications, substitutes and deletions are intended within the form and details thereof, without departing from the spirit and scope of the invention. Accordingly, it will be appreciated that in numerous instances some features of the invention will be employed without a corresponding use of other features. Further, those skilled in the art will understand that variations can be made in the number and arrangement of inventive elements illustrated and described in the above figures. It is intended that the scope of the appended claims include such changes and modifications.

What is claimed is:

1. A system for communicating packets to wired and wireless clients in a network, comprising:
a packet storage;
a queue manager;
a scheduler;
a shaper; and
a dynamic association between one or more ports, queue-groups and queues.

2. The system of claim 1, wherein a minimum number of queues is equal to a number of the wireless clients projected to simultaneously require the dynamic association in the network.

3. The system of claim 1, wherein the scheduler is capable of hierarchically scheduling packets to at least three levels, including: a port level, a queue-group level, and a queue level.

4. The system of claim 3, wherein the scheduler is further capable of:
port selection based at least in part on a port bandwidth;
queue-group scheduling based at least in part on one or more group shaping parameters and an inter-group bandwidth distribution; and
queue scheduling based at least in part on a quality of service (QoS) parameter, one or more queue shaping parameters and an inter-queue bandwidth distribution.

5. The system of claim 1, wherein the queue manager and the scheduler are capable of matching the packets that are destined for a particular roaming, wireless client device to a remote interface to which the particular client device is coupled.

6. The system of claim 1, wherein the scheduler and the shaper are capable of performing three phases of selection, including: a port phase, a queue-group phase, and a queue phase.

7. The system of claim 1, wherein the queue manager and the scheduler are each capable of handling multiple quality of service (QoS) queues, each QoS queue having its own servicing mechanism.

8. The system of claim 7, wherein the QoS queues include:
high priority queues, which are serviced first via strict priority QoS;
medium priority queues, which are serviced second via guaranteed bandwidth QoS; and
low priority queues, which are serviced third via deficit round robin (DRR) QoS.

9. A network appliance capable of communicating packets between wired and wireless clients and a network, comprising:
a packet buffer;
a set of queues;
a set of queue-groups;
a set of ports;
means for dynamically associating the packets between one or more of the sets of queues, queue-groups and ports;
means for enqueuing the packets using the packet buffer and the sets of queues, queue-groups and ports;
means for scheduling the packets using the packet buffer and the sets of queues, queue-groups and ports;
means for shaping the packets using the packet buffer and the sets of queues, queue-groups and ports.

10. The network appliance of claim 9, wherein a minimum number of queues is equal to a number of the wireless clients projected to simultaneously require the dynamic association in the network.

11. The network appliance of claim 9, wherein each group can include multiple quality of service (QoS) queues, each QoS queue having its own servicing mechanism.

12. The network appliance of claim 11, wherein the QoS queues include:
high priority queues, which are serviced first via strict priority QoS;
medium priority queues, which are serviced second via guaranteed bandwidth QoS; and
low priority queues, which are serviced third via deficit round robin (DRR) QoS.

13. A method for communicating packets to wired and wireless clients in a network, comprising:
dynamically associating the packets between one or more sets of queues, queue-groups and ports;
enqueuing the packets using a packet buffer and the sets of queues, queue-groups and ports;
scheduling the packets using the packet buffer and the sets of queues, queue-groups and ports;
shaping the packets using the packet buffer and the sets of queues, queue-groups and ports.

14. The method claim 13, wherein a minimum number of queues is equal to a number of the wireless clients projected to simultaneously require the dynamic association in the network.

15. The method of claim 13, wherein each group can include multiple quality of service (QoS) queues, each QoS queue having its own servicing mechanism.

16. The method of claim 15, wherein the QoS queues include:
high priority queues, which are serviced first via strict priority QoS;
medium priority queues, which are serviced second via guaranteed bandwidth QoS; and
low priority queues, which are serviced third via deficit round robin (DRR) QoS.

17. The method of claim 13, wherein the step of scheduling includes hierarchically scheduling the packets to at least three levels, including: a port level, a queue-group level, and a queue level.

18. The method of claim 17, wherein the step of scheduling further includes the steps of:
selecting a port from the set of ports based at least in part on a port bandwidth;
scheduling a queue-group from the set of queue-groups based at least in part on one or more group shaping parameters and an inter-group bandwidth distribution; and
scheduling a queue based at least in part on a quality of service (QoS) parameter, one or more queue shaping parameters and an inter-queue bandwidth distribution.

19. The method of claim 13, wherein the step of dynamically associating includes matching the packets that are destined for a particular roaming, wireless client device to a remote interface to which the particular client device is coupled.

20. A method for facilitating a wireless client to roam between access points in a network, comprising the steps of:
attaching the wireless client to a first queue associated with a first port;
detecting that the wireless client has roamed to an access point associated with a second port;
detaching, dynamically, the wireless client and the first queue from the first port upon roaming detection; and
reattaching, dynamically, the wireless client and the first queue to the second port without packet loss in the first queue.

21. A network appliance capable of communicating packets to a wireless client roaming between access points in a network, comprising:
a first port and a first queue associated with the wireless client;
a second port to which the wireless client has roamed;
means for detaching, dynamically, the wireless client and the first queue from the first port; and
means for reattaching, dynamically, the wireless client and the first queue to the second port without packet loss in the first queue.
